(19) United States
(12) Patent Application Publication
(10) Pub. No.: US 2026/0282160 A1
(43) Pub. Date: Sep. 17, 2026

(54) METHOD AND APPARATUS FOR MONITORING WIRELESS LINK IN WIRELESS COMMUNICATION SYSTEM

(71) Applicant: LG Electronics Inc., Seoul (KR)

(72) Inventors: Youngdae LEE, Seoul (KR); Seonwook KIM, Seoul (KR); Suckchel YANG, Seoul (KR); Sechang MYUNG, Seoul (KR)

(21) Appl. No.: 19/472,842

(22) PCT Filed: Apr. 8, 2024
(86) PCT No.: PCT/KR2024/004645

§ 371 Date: Oct. 6, 2025

(30) Foreign Application Priority Data
Apr. 6, 2023 (KR) 10-2023-0045678
May 12, 2023 (KR) 10-2023-0062024

(51) Int. Cl. H04W 76/28; H04B 7/06

(52) U.S. Cl. CPC H04W 76/28; H04B 7/0626

(57) ABSTRACT

A method and an apparatus for monitoring a wireless link in a wireless communication system are disclosed. A method performed by means of a UE in the wireless communication system, according to one embodiment of the present disclosure, may comprise the steps of: receiving first configuration information and second configuration information from a base station, the first configuration information including information related to cell DTX, and the second configuration information including information about one or more RLM RSs; and monitoring wireless link quality for the one or more RLM RSs.

### TECHNICAL FIELD

The present disclosure relates to a wireless communication system, and in more detail, relates to a method and an apparatus for radio link monitoring in a wireless communication system.

### BACKGROUND ART

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### DISCLOSURE

### Technical Problem

A technical object of the present disclosure is to provide a method and an apparatus for radio link monitoring in a wireless communication system.

In addition, an additional technical object of the present disclosure is to provide a method and an apparatus for radio link monitoring in a wireless communication system to which network energy saving (NES) (i.e., cell discontinuous transmission (DTX) and/or discontinuous reception (DRX)) is applied.

The technical objects to be achieved by the present disclosure are not limited to the above-described technical objects, and other technical ob]jects which are not described herein will be clearly understood by those skilled in the pertinent art from the following description.

### Technical Solution

A method performed a user equipment (UE) in a wireless communication system according to an aspect of the present disclosure may include: receiving first configuration information and second configuration information from a base station, wherein the first configuration information includes information related to cell discontinuous transmission (DTX), and the second configuration information includes information for one or more radio link monitoring (RLM) reference signals (RS); and monitoring radio link quality for the one or more RLM RSs. Based on out-of-sync (OOS), indicated by the radio link quality being lower than a threshold, being continuously counted a predetermined number of times, a timer used to determine whether a radio link failure (RLF) is considered may be started, and an counting of the OOS and/or an operation of the timer may be suspended during a non-active period of the cell DTX.

A method performed by a base station in a wireless communication system according to an additional aspect of the present disclosure may include: transmitting first configuration information and second configuration information from a base station, wherein the first configuration information includes information related to cell discontinuous transmission (DTX), and the second configuration information includes information for one or more radio link monitoring (RLM) reference signals (RS); and receiving an uplink transmission from the UE based on a detection of a radio link failure (RLF) based on monitoring of radio link quality for the one or more RLM RSs by the UE. Based on out-of-sync (OOS), indicated by the radio link quality being lower than a threshold, being continuously counted a predetermined number of times, a timer used to determine whether a radio link failure (RLF) is considered may be started, and an counting of the OOS and/or an operation of the timer may be suspended during a non-active period of the cell DTX.

### Technical Effects

According to an embodiment of the present disclosure, a UE can more accurately monitor a radio link by considering NES operations (i.e., cell DTX and/or cell DRX).

In addition, according to an embodiment of the present disclosure, when some beam resources (e.g., some reference signals, some antenna ports, some antenna elements, etc.) are deactivated according to NES operations (i.e., cell DTX and/or cell DRX), an operation of the UE declaring unnecessary multi-link failures can be prevented.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIG. 7 is a diagram for describing an example of a RLM and RLF detection operation according to the present disclosure.

FIG. 8 shows an example of a configuration a CSI-RS resource set according to the present disclosure.

FIG. 9 illustrates an RLM RS configuration method according to an embodiment of the present disclosure.

FIG. 10 is a diagram illustrating an operation of a UE for a radio link monitoring method according to an embodiment of the present disclosure.

FIG. 11 is a diagram illustrating an operation of a base station for a beam failure detection method according to an embodiment of the present disclosure.

FIG. 12 illustrates a block diagram of a wireless communication device according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. Abase station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS (Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802.16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR(New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN(New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information—reference signal resource indicator
CSI: channel state information
CSI-IM: channel state information—interference measurement
CSI-RS: channel state information—reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

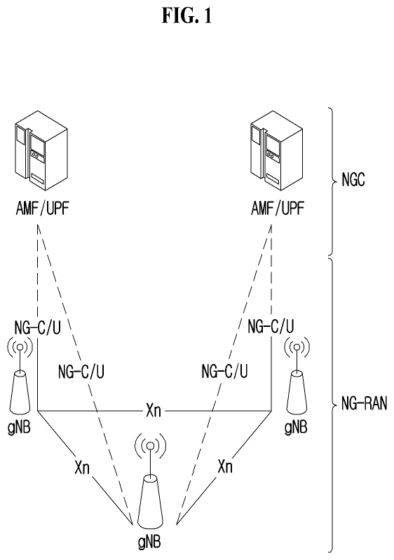

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC (Radio Link Control)/MAC/PHY) and UE. The gNBs are interconnected through a Xn interface. The gNB, in addition, is connected to an NGC (New Generation Core) through an NG interface. In more detail, the gNB is connected to an AMF (Access and Mobility Management Function) through an N2 interface, and is connected to a UPF (User Plane Function) through an N3 interface.

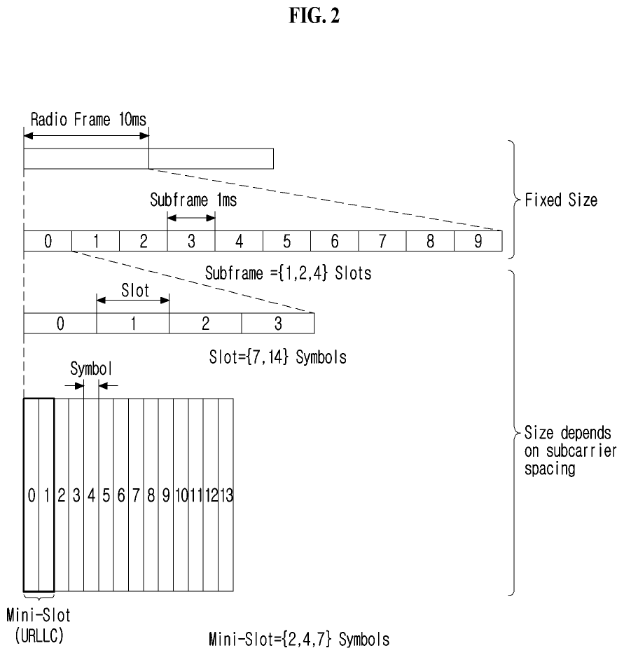

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, μ).

In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2 μ · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise.

An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Regarding a frame structure in an NR system, a size of a variety of fields in a time domain is expresses as a multiple of a time unit of Tc=1/(Δfmax·Nf). Here, Δfmax is 480 103 Hz and Nf is 4096. Downlink and uplink transmission is configured (organized) with a radio frame having a duration of Tf=1/(ΔfmaxNf/100)·Tc=10 ms. Here, a radio frame is configured with 10 subframes having a duration of Tsf=(ΔfmaxNf/1000)·Tc=1 ms, respectively. In this case, there may be one set of frames for an uplink and one set of frames for a downlink. In addition, transmission in an uplink frame No. i from a terminal should start earlier by TTA=(NTA+NTA,offset)Tc than a corresponding downlink frame in a corresponding terminal starts. For a subcarrier spacing configuration, slots are numbered in an increasing order of nsμ∈{0, . . . , Nslotsubframe,μ−1} in a subframe and are numbered in an increasing order of ns,fμ∈{0, . . . , Nslotframe,μ−1} in a radio frame. One slot is configured with Nsymbslot consecutive OFDM symbols and Nsymbslot is determined according to CP. A start of a slot nsμ in a subframe is temporally arranged with a start of an OFDM symbol nsμNsymbslot in the same subframe. All terminals may not perform transmission and reception at the same time, which means that all OFDM symbols of a downlink slot or an uplink slot may not be used.

Table 3 represents the number of OFDM symbols per slot (Nsymbslot), the number of slots per radio frame (Nslotframe,μ) and the number of slots per subframe (Nslotsubframe,μ) in a normal CP and Table 4 represents the number of OFDM symbols per slot, the number of slots per radio frame and the number of slots per subframe in an extended CP.

TABLE 3

| μ | Nsymbslot | Nslotframe, μ | Nslotsubframe, μ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | Nsymbslot | Nslotframe, μ | Nslotsubframe, μ |
|---|---|---|---|
| 2 | 12 | 40 | 4 |

FIG. 2 is an example on μ=2 (SCS is 60 kHz), 1 subframe may include 4 slots referring to Table 3. 1 subframe={1,2,4} slot shown in FIG. 2 is an example, the number of slots which may be included in 1 subframe is defined as in Table 3 or Table 4. In addition, a mini-slot may include 2, 4 or 7 symbols or more or less symbols.

Regarding a physical resource in a NR system, an antenna port, a resource grid, a resource element, a resource block, a carrier part, etc. may be considered. Hereinafter, the physical resources which may be considered in an NR system will be described in detail.

First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing.

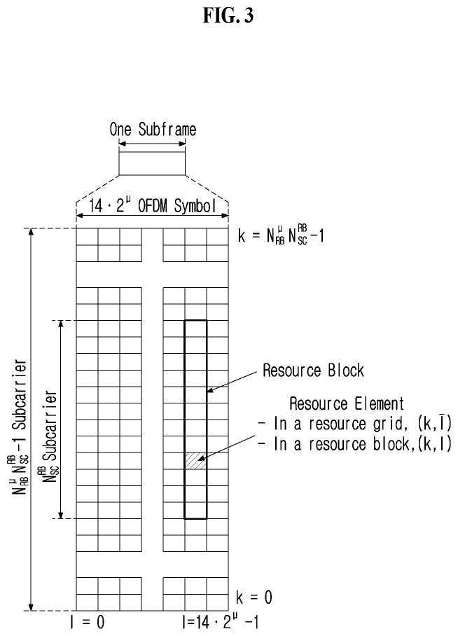

FIG. 3 illustrates a resource grid in a wireless communication system to which the present disclosure may be applied.

In reference to FIG. 3, it is illustratively described that a resource grid is configured with NRBμNscRB subcarriers in a frequency domain and one subframe is configured with 14·2^{μ} OFDM symbols, but it is not limited thereto. In an NR system, a transmitted signal is described by OFDM symbols of 2μNsymb(μ) and one or more resource grids configured with NRBμNscRB subcarriers. Here, NRBμ<NRBmax,μ. The NRBmax,μ represents a maximum transmission bandwidth, which may be different between an uplink and a downlink as well as between numerologies. In this case, one resource grid may be configured per and antenna port p. Each element of a resource grid for μ and an antenna port p is referred to as a resource element and is uniquely identified by an index pair (k,l′). Here, k=0, . . . , NRBμNscRB−1 is an index in a frequency domain and l′=0, . . . , 2μNsymb(μ)−1 refers to a position of a symbol in a subframe. When referring to a resource element in a slot, an index pair (k,l) is used. Here, l=0, . . . , Nsymbμ−1. A resource element (k,l′) for and an antenna port p corresponds to a complex value, ak,l′(p,μ). When there is no risk of confusion or when a specific antenna port or numerology is not specified, indexes p and μ may be dropped, whereupon a complex value may be ak,l′(p) or ak,l′. In addition, a resource block (RB) is defined as NscRB=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in ARFCN (absolute radio-frequency channel number).

Common resource blocks are numbered from 0 to the top in a frequency domain for a subcarrier spacing configuration. The center of subcarrier 0 of common resource block 0 for a subcarrier spacing configuration is identical to ‘point A’. A relationship between a common resource block number nCRBμ and a resource element (k,l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering in point A. Physical resource blocks are numbered from 0 to NBWP,isize,μ−1 in a bandwidth part (BWP) and i is a number of a BWP. A relationship between a physical resource block nPRB and a common resource block nCRB in BWP i is given by the following Equation 2.

$${n}_{CRB}^{μ} = {n}_{PRB}^{μ} + {N}_{BWP , i}^{start , μ} \qquad [ Equation 2 ]$$

NBWP,istart,μ is a common resource block that a BWP starts relatively to common resource block 0.

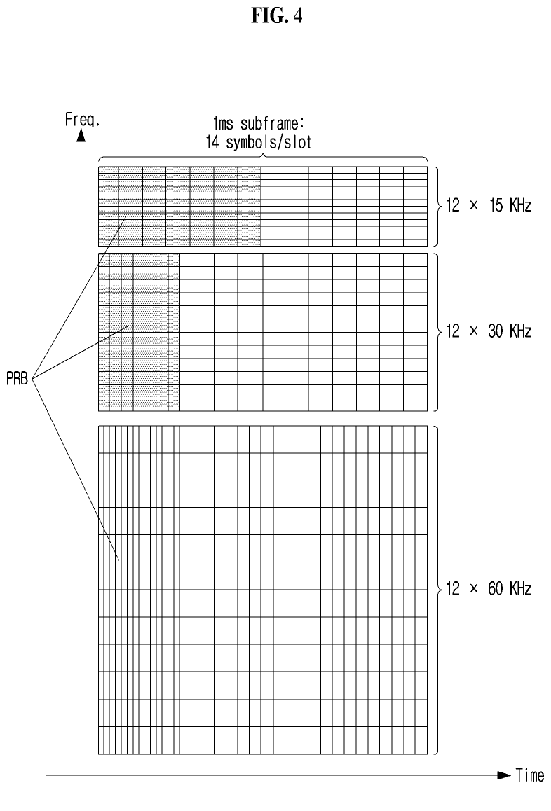

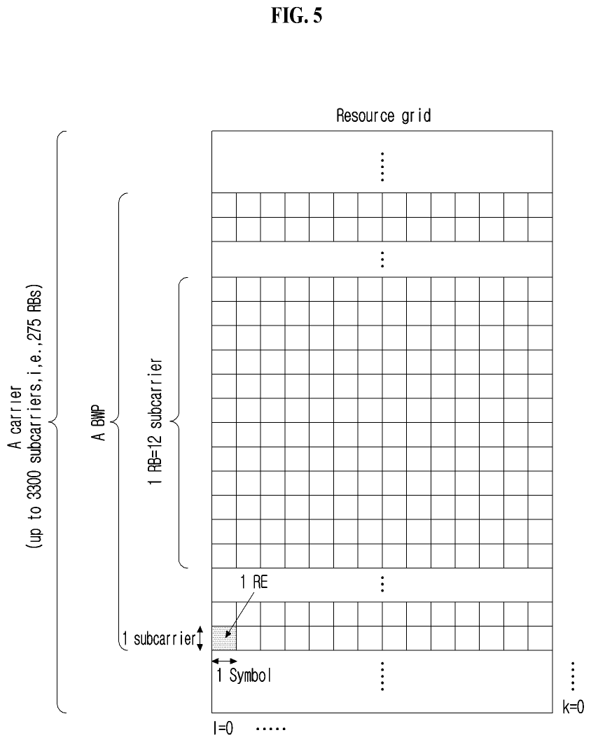

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI | |
|---|---|
| Format | Use |
| 0_0 | Scheduling of a PUSCH in one cell |
| 0_1 | Scheduling of one or multiple PUSCHs in one |
| | cell, or indication of cell group downlink |
| | feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid—Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined.

DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted.

DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted.

DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 10, 1_1 and 1_2 may include resource information (e.g., frequency resource allocation, time resource allocation, VRB (virtual resource block)-PRB (physical resource block) mapping, etc.), information related to a transport block (TB) (e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### Quasi-Co Location (QCL)

An antenna port is defined so that a channel where a symbol in an antenna port is transmitted can be inferred from a channel where other symbol in the same antenna port is transmitted. When a property of a channel where a symbol in one antenna port is carried may be inferred from a channel where a symbol in other antenna port is carried, it may be said that 2 antenna ports are in a QC/QCL (quasi co-located or quasi co-location) relationship.

Here, the channel property includes at least one of delay spread, doppler spread, frequency/doppler shift, average received power, received timing/average delay, or a spatial RX parameter. Here, a spatial Rx parameter means a spatial (Rx) channel property parameter such as an angle of arrival.

A terminal may be configured at list of up to M TCI-State configurations in a higher layer parameter PDSCH-Config to decode a PDSCH according to a detected PDCCH having intended DCI for a corresponding terminal and a given serving cell. The M depends on UE capability.

Each TCI-State includes a parameter for configuring a quasi co-location relationship between ports of one or two DL reference signals and a DM-RS of a PDSCH.

A quasi co-location relationship is configured by a higher layer parameter qcl-Type1 for a first DL RS and qcl-Type2 for a second DL RS (if configured). For two DL RSs, a QCL type is not the same regardless of whether a reference is a same DL RS or a different DL RS.

A quasi co-location type corresponding to each DL RS is given by a higher layer parameter qcl-Type of QCL-Info and may take one of the following values.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, when a target antenna port is a specific NZP CSI-RS, it may be indicated/configured that a corresponding NZP CSI-RS antenna port(s) is quasi-colocated with a specific TRS with regard to QCL-Type A and is quasi-colocated with a specific SSB with regard to QCL-Type D. A terminal received such indication/configuration may receive a corresponding NZP CSI-RS by using a doppler, delay value measured in a QCL-TypeA TRS and apply a Rx beam used for receiving QCL-TypeD SSB to reception of a corresponding NZP CSI-RS.

UE may receive an activation command by MAC CE signaling used to map up to 8 TCI states to a codepoint of a DCI field ‘Transmission Configuration Indication’.

### Radio Link Monitoring (RLM) Procedure

While monitoring the downlink radio link quality for the primary cell (PCell or PSCell), if it is determined that the radio link quality is degraded below the threshold value, the UE may report the RLM result to the base station.

Specifically, the downlink radio link quality of the primary cell may be monitored by the UE for the purpose of notifying/indicating an out-of-sync state or an in-sync state to a higher layer. The UE does not need to monitor the downlink radio link quality of the BWP other than the active downlink BWP in the primary cell.

If the active downlink BWP is an initial BWP and is for SS/PBCH block and CORESET multiplexing pattern 2 or 3, when the associated SS/PBCH block index is provided by ‘RadioLinkMonitoringRS’, which is a higher layer parameter, the UE may perform RLM using the associated SS/PBCH block.

And, for the UE, when the secondary cell group (SCG) is configured, the higher layer parameter ‘rlf-TimersAndConstants’ is provided, and it is configured to not be released, in the SCG, the downlink radio link quality of the PSCell may be monitored by the UE for the purpose of notifying/indicating an out-of-sync state/in-sync state to a higher layer. The UE does not need to monitor the downlink radio link quality in the DL BWP other than the active downlink BWP in the primary secondary cell.

The UE may be provided with the CSI-RS resource configuration index by the higher layer parameter ‘csi-RS-Index’ or the SS/PBCH block index by ‘ssb-Index’. ‘powerControlOffsetSS’ may not be applied to a CSI-RS resource configuration, and a terminal expects that only ‘noCDM’ in cdm-Type, only ‘one’ and ‘three’ in density, and only ‘1 port’ in ‘nrofPorts’ will be provided.

When a multi-downlink BWP is configured for the serving cell, the UE may perform a radio link monitoring operation using the RS(s) corresponding to the resource index provided by ‘RadioLinkMonitoringRS’ for the active downlink BWP. And, if ‘RadioLinkMonitoringRS’ is not provided for the active downlink BWP, the UE may perform a radio link monitoring operation using RS(s) provided through the active TCI state configured for PDCCH reception in CORESET of the active downlink BWP.

In a non-discontinuous reception (DRX) mode operation, the physical layer of a terminal assesses radio link quality against thresholds (Qout and Qin) configured by ‘rlmInSyncOutOfSyncThreshold’ once per indication period over a predetermined previous time period. A terminal determines an indication period as the maximum value between the shortest period for a radio link monitoring resource and 10 msec.

In a DRX mode operation, the physical layer of a terminal assesses radio link quality against thresholds (Qout and Qin) configured by ‘rlmInSyncOutOfSyncThreshold’ once per indication period over a predetermined previous time period. A terminal determines an indication period as the maximum value between the shortest period for a radio link monitoring resource and a DRX period.

In a frame in which radio link quality is evaluated, if the radio link quality is worse than a threshold (e.g., Qout) for all resources of a resource set for radio link monitoring, the physical layer of the UE may indicate to the higher layer that the state of the radio link is out of synchronization (‘out-of-sync’). In the frame in which the radio link quality is evaluated, if the radio link quality is better than the threshold Qin for any resource in the resource set for radio link monitoring, the physical layer of the UE may indicate to an higher layer that the state of the radio link is in a synchronized state (‘in-sync’).

When out-of-sync (OOS) occurs in L1 (layer 1, i.e., PHY), an indication may be sent to L2 (layer 2). When OOS occurs more than the predetermined number of times during a predetermined time period, L2 may be determined to be a radio link failure (RLF). Alternatively, when the number of retransmissions of a radio link control (RLC) packet reaches the maximum value, it may be determined to be a RLF. When a synchronization state (in-sync) (e.g., link recovery) does not occur for a certain period of time after RLF declaration, report therefor may be prepared/updated and a RRC re-establishment process may be performed. This report may be named, e.g., varRLF-Report, and may include identification information on the best SSB and/or CSI-RS resource(s) of neighboring cell(s) configured for a purpose of radio resource management (RRM) and quality information (e.g., a RSRP, a RSRQ, a SINR, etc.). When this report is available, a terminal may report to a network an indication (e.g., via a 1-bit indicator) that information corresponding to the report is available in a completion message of a RRC re-establishment process. For reference, a RRC re-establishment process may include a terminal transmitting a RRC re-establishment request message (e.g., RRCReestablishmentRequest) to a network, a terminal receiving a RRC re-establishment message (e.g., RRCReestablishment) from a network and a terminal transmitting a RRC re-establishment completion message (e.g., RRCReestablishmentComplete) to a network.

Based on report availability indication information from a terminal, a base station may request report information of a terminal (e.g., VarRLF-Report) through a terminal information process after a RRC re-establishment process. A terminal information process may include, for example, a terminal receiving a terminal information request message (e.g., UEInformationRequest) from a network and a terminal transmitting a terminal information response message (e.g., UEInformationResponse) to a network. For example, report information of a terminal (e.g., VarRLF-Report) may be included in a terminal information response message (e.g., UEInformationResponse) and reported to a base station.

A terminal may receive a configuration for a RS for separate RLM for each DL BWP of SpCell (PCell, PSCell) from a base station. In other words, a base station may provide a RRC parameter failureDetectionResourcesToAddModList to a terminal, and a terminal may monitor a RS for RLM according to the RadioLinkMonitoringRS configuration of failureDetectionResourcesToAddModList. The RadioLinkMonitoringRS configuration of failureDetectionResourcesToAddModList provided by a base station may include a CSI-RS resource configuration index (csi-RS-Index) or a SS/PBCH block index (ssb-Index) corresponding to up to NLR-RL CSI-RS resources or SSB resources. A terminal may perform RLM based on up to NRLM RSs (CSI-RSs or SSBs) among up to NLR-RLM CSI-RS resources or SSB resources according to a base station configuration.

When a separate RS (i.e., RadioLinkMonitoringRS) configuration for RLM is not provided to a terminal, a terminal may perform RLM based on the active TCI state applied when receiving a PDCCH. For example, when the TCI state including one or a plurality of CSI-RS resources is provided for receiving a PDCCH, a terminal may perform RLM as follows.
When the active TCI-state for PDCCH reception includes only one RS, a terminal uses a RS provided for the active TCI-state for a PDCCH for radio link monitoring.
When the active TCI-state for PDCCH reception includes two RSs, a terminal performs RLM based on one RS having a QCL-TypeD relationship among them. Here, a terminal does not expect that both RSs have a QCL-TypeD relationship.
A terminal does not use an aperiodic or semi-persistent RS for radio link monitoring. For CSI-RS-based RLM, RLM is performed by using a periodic CSI-RS having a single port restriction.
When Lmax=4, a terminal prioritizes the TCI state associated with the CORESET of a search space set (SS set) with the shortest monitoring periodicity, and when there are a plurality of CORESETs corresponding to the shortest SS set, a terminal performs RLM by prioritizing the highest CORESET index. Here, Lmax corresponds to the maximum number of SS/PBCH blocks per half frame.

The value of NLR-RLM and NRLM according to Lmax may be given as follows.

TABLE 6

| Lmax | NLR-RLM | NRLM |
|---|---|---|
| 4 | 2 | 2 |
| 8 | 6 | 4 |
| 64 | 8 | 8 |

### RLM and RLF Detection Considering Network Energy Saving (NES)

The above-described descriptions can be applied in combination with the methods proposed in this disclosure, which will be described later, or can be supplemented to clarify the technical features of the methods proposed in this disclosure. In this document, “/” means “and,” “or,” or “and/or,” depending on the context.

A terminal may support reception based on beamforming in receiving a downlink. In other words, a terminal may receive a downlink signal by using a specific beam among a plurality of candidate beams. When a terminal is in a connected mode, a base station and a terminal may maintain an optimal beam for a terminal through a beam management (BM) process. Accordingly, a base station may use an optimal transmission (TX) beam suitable for a terminal to transmit a downlink physical channel (e.g., a PDCCH, a PDSCH, etc.), and a terminal may use an optimal reception (RX) beam to receive a downlink physical channel.

In order to refine a wireless communication system, a method for reducing the power consumption of a network node (e.g., a base station, a cell, a TRP, a relays, etc.) is being discussed. For example, a network node that may use a plurality of TX beams and/or RX beams may perform communication with a terminal through some beams (e.g., CSI-RS resources, SSB resources, etc.)(s) in a specific time period and may not perform communication with a terminal through the remaining beam(s) in order to reduce its power consumption. In addition, a network node may perform communication with a terminal through some other beam(s) in a different time period and may not perform communication with a terminal through the remaining beam(s). In other words, a network node may deactivate (or turn OFF) some beam resource(s) that are the same/different for each time period for NES.

When a terminal performs RLM for an activated beam/RS in a specific time period, whether to detect/declare RLF may be determined as described above based on the quality/measurement results of a corresponding beam/RS. Meanwhile, when a terminal performs RLM for a deactivated beam/RS in a specific time period and accordingly, RLF is detected/declared, such RLM and RLF may correspond to a procedure that is performed unnecessarily. When a network node deactivates a different beam/RS for a plurality of time periods, a situation may frequently occur where a terminal performs unnecessary RLM and accordingly, declares unnecessary RLF.

The present disclosure describes various examples of refining RLM and RLF detection operations of a terminal belonging to a network node supporting NES. Specifically, the present disclosure includes various examples for causing a terminal attempting to connecting or connected with a network node performing a NES operation to perform RLM and detect RLF by applying a different RS according to whether to perform a NES operation. In examples below, it is described by mainly assuming a RLM/RLF operation, but the scope of the present disclosure is not limited thereto, and the examples of the present disclosure may also be applied similarly to a beam/a RS targeted for beam failure detection (BFD)/beam failure recovery (BFR).

In the present disclosure, when a network node operates in a NES mode, it may mean that the following operation is performed. For example, a network node may configure a plurality of periods (i.e., the discontinuous transmission (DTX) periods of a network node) that deactivate/turn off the transmission of specific DL signal(s) during a specific time period in advance. A network node may dynamically indicate one OFF period among a plurality of configured OFF periods to a terminal. A terminal may know that a DL signal associated with a corresponding OFF period will not be transmitted from a network node within an indicated OFF period. Accordingly, the power consumption of a network node and a terminal may be saved.

In a NES mode, an OFF period may be defined in a time, frequency and/or spatial domain. For example, an OFF period may be defined in a time domain, and the time length of a plurality of OFF periods may be the same or different. For example, an OFF period may be defined in a frequency domain through a method such as BWP switching, dynamic RB adaptation, etc. For example, an OFF period may be defined in a spatial domain by semi-statically or dynamically deactivating the specific antenna port of a network node (i.e., a network node does not transmit/receive a radio signal through a corresponding antenna port).

In order to apply a RLM/RLF operation according to the present disclosure, a network node may activate or deactivate a NES mode. For example, when one base station controls a plurality of cells, whether to activate a NES mode may be applied independently for each cell. In addition, a network node may inform a terminal of information about NES activation or deactivation.

Unless otherwise limited in the present disclosure, a configuration for a terminal by a base station may include providing corresponding configuration information to a terminal through higher layer (e.g., RRC) signaling. Unless otherwise limited in the present disclosure, a command/an indication for a terminal by a base station may include providing a corresponding command/indication to a terminal through MAC CE and/or DCI. Unless otherwise limited in the present disclosure, information predefined for a base station and a terminal may include information that is held in advance by a base station and a terminal without separate signaling/command/indication for corresponding information.

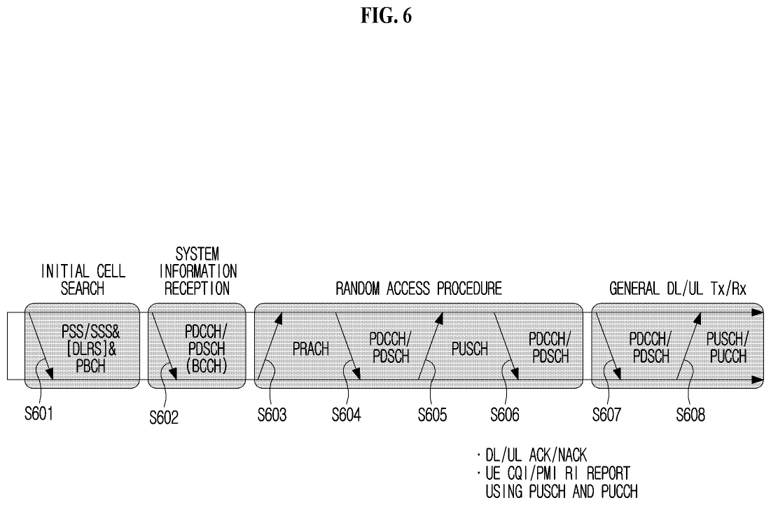

FIG. 7 is a diagram for describing an example of a RLM and RLF detection operation according to the present disclosure.

In S710, a network node may provide a terminal with information related to NES application through a RRC configuration (e.g., information on at least one OFF period (candidate), information on beam/RS resource(s) associated with each OFF period (candidate)).

In S720, a network node may indicate NES mode activation to a terminal. A NES mode activation indication may include indicating at least one OFF period applied to a corresponding terminal among at least one configured OFF period (candidate).

In S730, a network node may transmit NES mode-based RLM-RS(s) to a terminal.

In S740, a terminal may perform measurement on a RLM-RS. In other words, a terminal may perform RLM based on measurement on an activated RS (e.g., RLM-RS) excluding a RS that is deactivated in a corresponding OFF period in each of the OFF period(s) indicated to itself.

In S750, a terminal may determine whether RLF is detected based on a RLM result, and when RLF is detected, may declare RLF to a higher layer.

In S760, a terminal may perform a cell selection procedure due to RLF detection, and in S770, a terminal may perform a random access procedure (e.g., PRACH transmission) for requesting RRC connection re-establishment to a network node (e.g., another cell).

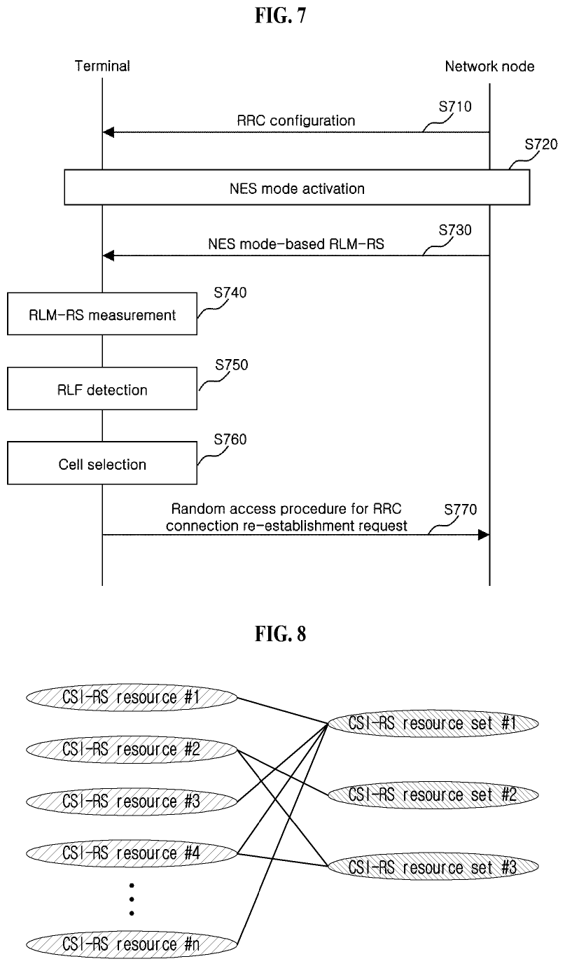

FIG. 8 shows an example of a configuration a CSI-RS resource set according to the present disclosure.

A base station may configure at least one RS resource set for a terminal for a RS for RLM. A configuration for this RS for RLM may be provided for each terminal (i.e., in a terminal-specific way) or commonly to a plurality of terminals. For example, a RS resource may correspond to a CSI-RS resource or a SSB resource/index, and a RS resource set may correspond to a CSI-RS resource set or a SSB resource/index set. In addition, an index may be assigned to each RS resource set.

Although FIG. 8 shows an example assuming that a RS for RLM is a CSI-RS, the present disclosure may configure a RS resource (set) for RLM based on another RS or SSB.

In the example of FIG. 8, one CSI-RS resource may be included in one CSI-RS resource set or may belong to a plurality of different CSI-RS resource sets. One CSI-RS resource set may include one CSI-RS resource or may include a plurality of different CSI-RS resources. The number of CSI-RS resources belonging to a different CSI-RS resource set may be the same or different.

Hereinafter, various examples of NES-based RLM/RLF according to the present disclosure are described.

In the present disclosure, for RLM operation of a UE, different first and second periods can be configured/determined according to one or more of the following cases.
Case 1: A first period operating in NES mode and a second period operating in non-NES mode
Case 2: A first period which is a Cell DTX inactive time (i.e., a time period during which the base station does not perform TX for a specific cell) and a second period which is a Cell DTX active time (i.e., a time period during which the base station performs TX for a specific cell)
Case 3: A first period, which is a UE DRX inactive time (i.e., a time period during which the UE does not perform RX) and a second period, which is a UE DRX active time (i.e., a time period during which the UE performs RX)

Depending on the configuration of the base station, only the second period may be configured or both the first period and the second period may be configured per cell, and/or per BWP, and/or per frequency, and/or per RS for radio link failure (RLF), and/or per antenna port (AP), and/or per AP group, and/or per antenna element group.

In addition, the base station can separately set the first period and the second period for each of the cases described above. In this case, there may be cases where a specific time duration belongs to the first period or the second period for different cases. Considering this, the UE can perform the operation of the first period proposed in the present disclosure when the specific time duration belongs only to the first period, and can perform the operation of the second period proposed in the present disclosure when the specific time duration belongs only to the second period. If the first period and part (or all) of the second period overlap, the UE can perform only the operation of the first period proposed in the present disclosure in the overlapping period or can perform the operation of the first period preferentially. Alternatively, conversely, if the first period and part (or all) of the second period overlap, the UE can perform only the operation of the second period proposed in the overlapping period or can perform the operation of the second period preferentially.

According to one embodiment of the present disclosure, it can be explicitly configured for RLM-RS.

The base station may provide the UE with multiple RS configurations (i.e., configuration information for multiple RLM-RSs) for RLM. For example, the multiple RLM-RSs may correspond to periodic CSI-RS resources and/or SSB resources. The UE may perform RLM based on one RLM-RS configuration among the multiple RLM-RS configurations. For example, the UE may perform RLM by applying different RLM RS configurations to the first period and the second period. Here, the base station may assign an RS index (e.g., #a, #b, . . . ) to the UE for each RLM-RS configuration. For example, the RadioLinkMonitoringRS parameter in the higher layer parameter failureDetectionResourcesToAddModList may include multiple RLM-RSs (e.g., RLM-RS configurations assigned with #a, #b, . . . ). Alternatively, the failureDetectionResourcesToAddModList parameter may include multiple RLM-RSs (e.g., RLM-RS configurations assigned #a, #b, . . . ). Alternatively, multiple failureDetectionResourcesToAddModList parameters may be configured, and each failureDetectionResourcesToAddModList may include a different RLM-RS configuration, for example, a first failureDetectionResourcesToAddModList of the RRC message may include configuration information for RLM-RS #a, a second failureDetectionResourcesToAddModList may contain configuration information for RLM-RS #b, and so on.

In this configuration, the base station may provide the UE with different RLM RS configurations (RadioLinkMonitoringRS) or multiple different RLM RSs for the first period and the second period. In this case, the UE may perform RLM based on the RadioLinkMonitoringRS configuration for the first period or the RLM RS for the first period in the first period, and the terminal may perform RLM based on the RadioLinkMonitoringRS configuration for the second period or the RLM RS for the second period in the second period. In this case, the different RadioLinkMonitoringRS configurations may be configured with different RadioLinkMonitoringRS-Ids, or the different RadioLinkMonitoringRS configurations may separately configure the RLM RS for the first period and the RLM RS for the second period for the same RadioLinkMonitoringRS-Id. In the latter case, an indicator may be included within the RadioLinkMonitoringRS configuration indicating whether the RS is for the first period or the RS is for the second period.

Alternatively, the base station may provide the UE with different RLM configurations (RadioLinkMonitoringConfig) for the first and second periods. The different RadioLinkMonitoringConfig configurations may each configured an RLM RS for the first period and an RLM RS for the second period.

Table 7 illustrates examples of RLM configurations (RadioLinkMonitoringConfig).

TABLE 7
RadioLinkMonitoringConfig ::= SEQUENCE {
failureDetectionResourcesToAddModList SEQUENCE
(SIZE(1..maxNrofFailureDetectionResources)) OF RadioLinkMonitoringRS OPTIONAL, -
- Need N
failureDetectionResourcesToReleaseList SEQUENCE
(SIZE(1..maxNrofFailureDetectionResources)) OF RadioLinkMonitoringRS-Id
OPTIONAL, -- Need N
. . .
}
RadioLinkMonitoringRS ::= SEQUENCE
radioLinkMonitoringRS-Id RadioLinkMonitoringRS-Id,
purpose ENUMERATED {beamFailure, rlf, both},
detectionResource CHOICE {
ssb-Index SSB-Index,
csi-RS-Index NZP-CSI-RS-ResourceId
},
. . .
}

The RadioLinkonitoringConfig configuration or the RadioLinkMonitoringRS or the RLM RS may correspond to one of a spatial domain adaptation pattern or a power domain adaptation pattern. Here, the spatial domain adaptation pattern may correspond to a specific number of antenna ports (or an antenna port on/off pattern) or a specific CSI-RS power value (e.g., a CSI-RS power value determined by a powerControlOffsetSS parameter, which is a power offset value between SSS and CSI-RS). In addition, the power domain adaptation pattern may mean that a power offset value (e.g., a power offset value determined by a powerControlOffset parameter, which is a power offset value between PDSCH and CSI-RS, a power offset value between SSS and CSI-RS, or a powerControlOffsetSS parameter, which is a power offset value between SSS and CSI-RS) is changed.

Different RadioLinkMonitoringConfig configurations or RadioLinkMonitoringRSs or RLM RSs may correspond to the same or different spatial domain adaptation patterns or power domain adaptation patterns. The base station may include or link the RadioLinkMonitoringConfig configurations or RadioLinkMonitoringRSs or RLM RSs to a single sub-configuration. In this case, which sub-configuration is used/applied/activated may be determined based on an explicit command or implicit rule of the base station. Accordingly, depending on which sub-configuration is used/applied/activated, the UE may perform RLM based on the RadioLinkMonitoringConfig configuration or RadioLinkMonitoringRS configuration or RadioLinkMonitoringRS-Id or RLM RS mapped to the corresponding sub-configuration. If, according to the explicit command or implicit rule of the base station, among the total L sub-configurations (L is an integer greater than 0), N sub-configuration(s) (N<=L) are determined to be used/applied/activated, the UE may select one sub-configuration among the N sub-configurations(s) according to one of the following rules. Then, the UE may perform RLM based on the RadioLinkMonitoringConfig configuration, RadioLinkMonitoringRS configuration, RadioLinkMonitoringRS-Id, or RLM RS mapped to the selected sub-configuration.
Opt 1: Among N sub-configurations, the sub-configuration corresponding to the lowest sub-configuration index may be selected.
Opt 2: Among N sub-configurations, the sub-configuration corresponding to the highest sub-configuration index may be selected.
Opt 3: Among N sub-configurations, the sub-configuration corresponding to the sub-configuration index indicated by the base station via MAC CE or DCI may be selected.
Opt 4: Among N sub-configurations, the sub-configuration designated by the base station via an RRC message, or the sub-configuration corresponding to the default or highest priority may be selected.

Meanwhile, the base station may provide the RadioLinkMonitoringRS configuration or RLM RS to the UE only for the second period. i) If a separate RadioLinkMonitoringRS configuration or RLM RS configuration for the first period is not provided to the UE, or ii) if the RadioLinkMonitoringRS or RLM RS configuration is not applied in the first period, or iii) (regardless of the configuration), for the first period, the UE may perform RLM based on the active TCI state applied when receiving a PDCCH. For example, if a TCI-state including one or more CSI-RSs or SSBs is provided for PDCCH reception, the UE may perform RLM as follows in the first period. Here, the terminal may determine only the SSB as the RS for performing RLM in the first period.
If the active TCI state for PDCCH reception includes only one RS, the UE may use the RS provided for the active TCI state for a PDCCH for RLM.
If the active TCI state for PDCCH reception includes two RSs, the UE may perform RLM based on one RS that has a dual QCL-TypeD relationship (i.e., configured as QCL-TypeD). Here, the UE may not expect both RSs to have QCL-TypeD relationships.
The UE may not use aperiodic or semi-persistent RSs for RLM. If CSI-RS-based RLM is used, the UE may perform RLM using periodic CSI-RSs with single port restrictions.
When Lmax=4, the terminal may prioritize the TCI state linked/associated with the CORESET of the search space set (SS set) with the shortest monitoring periodicity, and may use the RS provided for that TCI state for RLM. Here, if multiple CORESETs are linked/associated, RLM may be performed by prioritizing a specific CORSESET (e.g., the CORESET with the highest CORESET index).

In addition, for NES operation, the base station can configure multiple RLM-RSs for the UE, and an RS index can be assigned to each RLM-RS. The base station can explicitly (in advance) configure the RLM-RS associated with each RS index. According to the explicit configuration/command/instruction of the base station or implicit rule, the base station and the UE can activate only one RS index, i.e., only one RS. The UE can determine only one activated RS as a valid RLM-RS, and perform RLM using only the valid RLM-RS.

For example, a base station can configure multiple RLM-RSs via an RRC message and indicate the activation of one of the RLM-RSs via a DCI, MAC CE, or RRC message.

As a specific example, RLM-RSs #a, #b, . . . can be configured via an RRC message, and the first RLM-RS to be activated or deactivated (e.g., #b) can be specified via the same RRC message. A UE receiving this RRC message can configure multiple RLM-RSs and activate or deactivate specific RLM-RS(s).

As another example, RLM-RS #a, #b . . . may be configured through a first RRC message, and an RLM-RS (e.g., #b) to be activated or deactivated may be specified through a DCI or MAC CE or a second RRC message. A UE receiving the first RRC message may configure multiple RLM-RSs, and activate or deactivate RLM-RS(s) that were deactivated according to the DCI or MAC CE or the second RRC message. If only one RLM-RS can be activated at the same time, the remaining RLM-RS(s) may be deactivated (without separate configuration/indication) upon activation of a specific RLM-RS. If two RLM-RSs are configured, one RLM-RS may be deactivated (without separate configuration/indication) upon deactivation of a specific RLM-RS. Alternatively, all RLM-RSs may be configured/indicated to be deactivated or all RLM-RSs may be configured/indicated to be enabled via DCI or MAC CE or a second RRC message.

As another example, if the base station indicates the NES mode or the UE switches to the NES mode, the UE may activate only a specific RLM-RS mapped to the NES mode. If the base station indicates the non-NES mode or the UE switches to the non-NES mode, the UE may perform RLM by activating only the specific RLM-RS mapped to the non-NES mode or activating other RLM-RS(s) other than the specific RLM-RS mapped to the NES mode. To this end, the base station may configure/indicate a specific RLM-RS mapped to the NES mode. Additionally, the base station may configure/indicate a specific RLM-RS mapped to the non-NES mode.

According to one embodiment of the present disclosure, the RLM-RS may be implicitly configured.

i) If there is no valid RLM-RS in the explicit configuration for RLM-RS provided by the base station, or ii) if it is the first time period, or iii) If the base station indicates in a DCI/MAC CE/RRC message for the first period, the UE may determine/select an RLM-RS by applying implicit configuration/rules.

If the UE determines that there is no valid RLM-RS in the explicit configuration for RLM-RS provided by the base station, one or more of the following cases may apply:
When a separate configuration for RLM-RS (e.g., RadioLinkMonitoringRS) is not provided to the UE;
When the activation configuration/indication of a specific RLM-RS is not provided to the UE from the base station for the corresponding cell (or target cell) in the event of a handover, cell addition, or cell activation;
When all RLM-RSs explicitly provided by the base station are deactivated; or
When all beam resources corresponding to RLM-RSs explicitly provided by NES operation are turned off (or deactivated); or
In case of the first period.

Additionally, if there is no valid RLM-RS in the explicit configuration or if it is the first period, the UE may perform RLM using one of the following methods. Conversely, if there is a valid RLM-RS in the explicit configuration or if it is the second period, the UE may perform RLM using the valid RLM-RS in the explicit configuration.

Method 1: The UE may determine the RLM-RS based on the TCI state associated with the CORESET for PDCCH monitoring. For example, the configuration information for the TCI state associated with the CORESET may include QCL information, and the QCL information may indicate an identifier/index for a CSI-RS resource/SSB resource. In the following description, the CSI-RS resource/SSB resource indicated in the configuration information for the TCI state is referred to as a CSI-RS resource linked to the corresponding TCI state. For example, the UE may determine/select a periodic CSI-RS (P-CSI-RS) having the same index as the CSI-RS linked to the TCI state associated with the CORESET or an SSB having a QCL relationship with the CSI-RS linked to the TCI state as the RLM-RS.

For example, if a specific beam is turned off (or deactivated), the base station may change the TCI state (associated with the CORESET) for PDCCH monitoring performed by the corresponding UE. In this case, the UE (according to the configuration/indication of the base station) may change the TCI state for PDCCH monitoring and determine the RS corresponding to the changed TCI state as the RLM-RS to perform RLM.

For example, if there is no valid RLM-RS in the explicit configuration or if it is the first period, the UE may determine the SSB linked to the TCI state associated with the CORESET for PDCCH monitoring as the RLM-RS. On the other hand, if there is a valid RLM-RS in the explicit configuration or if it is the second period, the UE may perform RLM by applying the valid CSI-RS-based RLM-RS in the explicit configuration.

Method 2: If one or more CORESETs are configured for PDCCH monitoring, the UE may determine/select one CORESET according to a specific rule. For example, a P-CSI-RS or SSB with the same index as a CSI-RS linked to a TCI state associated with the determined/selected CORESET may be determined as an RLM-RS. Alternatively, a P-CSI-RS with a QCL relationship with the TCI state associated with the determined/selected CORESET (or with a CSI-RS linked to the TCI state) or an SSB with a QCL relationship with the CSI-RS linked to the associated TCI state may be determined as an RLM-RS. Alternatively, an SSB with a QCL relationship with a TCI state associated with the selected CORESET may be determined as an RLM-RS.

Examples of specific rules for a CORESET that a UE determines/selects (for RLM-RS) from among one or more CORESETs for PDCCH monitoring are as follows:

Method 2-1: A UE may determine/select a CORESET with the lowest index from among one or more CORESETs as the aforementioned CORESET.

Alternatively, the UE may determine/select the CORESET with the highest index among one or more CORESETs as the aforementioned CORESET.

Method 2-2: The UE may determine/select a specific CORESET (or a default CORESET, or a predefined CORESET) preset by the base station among one or more CORESETs as the aforementioned CORESET.

Alternatively, the UE may determine/select a default CORESET preconfigured by the base station among one or more CORESETs as the aforementioned CORESET.

Alternatively, the UE may determine/select a predefined CORESET among one or more CORESETs as the aforementioned CORESET.

Method 2-3: If Lmax=4 (where Lmax is the maximum number of SS/PBCH blocks per half frame) and there is only one CORESET associated with the SS (search space) set with the shortest monitoring period, the UE may determine/select the CORESET as the aforementioned CORESET.

Alternatively, if Lmax=4 and there are multiple CORESETs associated with the SS set with the shortest monitoring period, the UE may determine/select the CORESET with the lowest index among the multiple CORESETs as the aforementioned CORESET.

Alternatively, if Lmax=4 and there are multiple CORESETs associated with the SS set with the shortest monitoring period, the UE may determine/select the CORESET with the highest index among the multiple CORESETs as the aforementioned CORESET.

In the aforementioned method 2, if there is no valid RLM-RS in the explicit configuration or if the selected CORESET is in the first period, the UE may determine an SSB that is in a QCL relationship with the CSI-RS linked to the TCI state associated with the selected CORESET as the RLM-RS. Conversely, if there is a valid RLM-RS in the explicit configuration or if the selected CORESET is in the second period, BFD may be performed by applying an RLM-RS based on the valid CSI-RS in the explicit configuration.

Method 3: The UE may determine an RLM-RS based on a TCI state associated with a recently performed random access procedure (or RACH procedure).

For example, the UE may determine a P-CSI-RS or SSB with the same index as the CSI-RS linked to the TCI state determined according to the recently performed random access procedure as the RLM-RS.

Alternatively, the UE may determine a P-CSI-RS or SSB having a QCL relationship with a TCI state (or a CSI-RS linked to the TCI state) determined according to a recently performed random access procedure as an RLM-RS.

Alternatively, the UE may determine a CSI-RS or SSB selected according to a recently performed random access procedure as an RLM-RS.

Alternatively, the UE may determine a P-CSI-RS or SSB having a QCL relationship with a CSI-RS selected according to a recently performed random access procedure as an RLM-RS.

Method 4: The UE may determine a P-CSI-RS having an index equal to an index of an SSB resource that is equal to or greater than a predetermined threshold (e.g., a threshold for reception strength, reception quality, etc.) as an RLM-RS.

Alternatively, the UE may determine a P-CSI-RS or SSB having a QCL relationship with a CSI-RS having an index equal to an index of an SSB resource that is equal to or greater than a predetermined threshold as an RLM-RS.

Method 5: The base station can indicate the UE whether to turn on/off (or activate/deactivate) a specific SSB resource (or SSB beam) or a specific CSI-RS resource (or CSI-RS beam). In this case, the UE can determine the SSB linked to the TCI state indicated as on (or activated) by the base station as an RLM-RS, or determine the P-CSI-RS having the same index as the CSI-RS linked to the TCI state indicated as on (or activated) as an RLM-RS.

Alternatively, the UE can determine the P-CSI-RS having a QCL relationship with the TCI state indicated as on (or activated) by the base station (or with the CSI-RS linked to the corresponding TCI state) as an RLM-RS. For example, a P-CSI-RS linked to an index of an SSB resource indicated as on (or activated) may be determined as an RLM-RS, or a P-CSI-RS having a QCL relationship with the P-CSI-RS may be determined as an RLM-RS.

Method 6: An SSB or CSI-RS located in a frequency range within or outside the UE's active BWP may be determined as an RLM-RS. In this case, the SSB may be a cell-defined SSB (i.e., a CD-SSB) or a non-CD-SSB. A CD-SSB is transmitted including the master information block (MIB) of the physical broadcast channel (PBCH), and a non-CD-SSB is transmitted without including the PBCH's MIB.

For example, if there is no valid RLM-RS in the explicit configuration or if it is the first period, the UE may determine a CSI-RS linked to a TCI state associated with a CORESET for PDCCH monitoring, or an SSB in a QCL relationship with the linked CSI-RS, as an RLM-RS.

Here, some or all of the SSB or CSI-RS determined as RLM-RS may be located in a frequency range outside the active BWP of the UE. On the other hand, if there is a valid RLM-RS in the explicit configuration or if it is the second period, a valid CSI-RS in the explicit configuration may be determined as an RLM-RS and RLM may be performed.

Meanwhile, according to an embodiment of the present disclosure, a CSI reporting configuration (i.e., CSI-ReportConfig) may include multiple CSI reporting sub-configurations. L (>1) sub-configurations may be configured within a CSI-ReportConfig configuration, and each sub-configuration may correspond to one of a spatial domain adaptation pattern or a power domain adaptation pattern. Here, the spatial domain adaptation pattern may correspond to a specific number of antenna ports (or an antenna port on/off pattern) or may correspond to a specific CSI-RS power value (e.g., a CSI-RS power value determined by a powerControlOffsetSS parameter, which is a power offset value between an SSS and a CSI-RS).

Additionally, the power domain adaptation pattern may mean that the power offset value (e.g., the power offset value determined by the powerControlOffset parameter, which is the power offset value between PDSCH and CSI-RS, the powerControlOffsetSS parameter, which is the power offset value between SSS and CSI-RS, etc.) changes.

For a CSI report configuration that includes one or more sub-configurations, at least one of the following parameters may be included and configured for each sub-configuration for Type 1 spatial domain (SD) adaptation:
N1, N2 for a single panel, and N1, N2, Ng for a multi-panel: where N1 and N2 represent the number of antenna ports in the first and second dimensions, respectively, and Ng may represent the number of panels.
Port subset indication
Rank restriction
Codebook subset restriction
Codebook type supported for PMI (e.g., Type-I or Type-II)
Report quantity: This indicates the CSI-related quantity to be reported.
Report Frequency Configuration (reportFreqConfiguration): This refers to the reporting configuration in the frequency domain.
Group identifier for NZP CSI-RS resource(s) within the resource set for channel measurement.

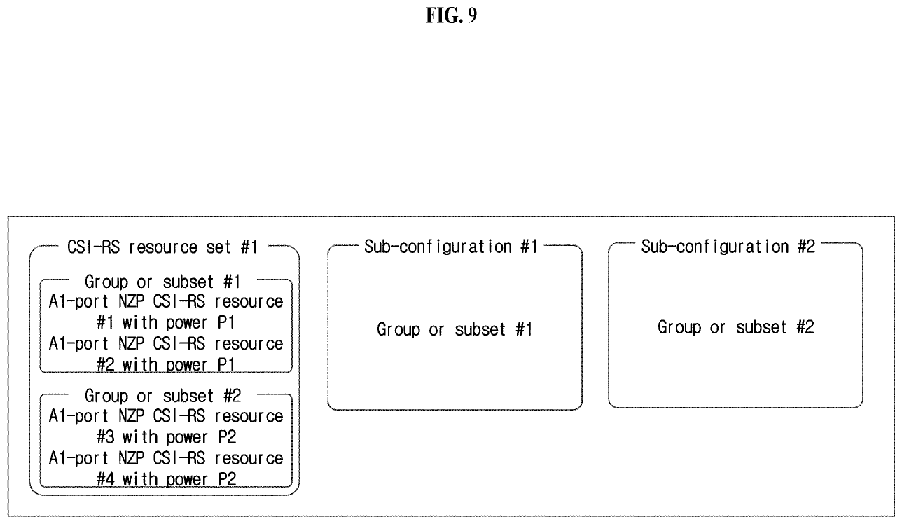

FIG. 9 illustrates an RLM RS configuration method according to an embodiment of the present disclosure.

Referring to FIG. 9, the base station may configure a specific CSI-RS resource set (e.g., #1) as shown in FIG. 9 in the CSI reporting configuration, and may configure multiple sub-configurations according to different spatial domain adaptation patterns or different power domain adaptation patterns within the specific CSI-RS resource set. For example, as shown in FIG. 9, different sub-configurations #1 and #2 may be configured for different power offsets P1 and P2.

Here, each sub-configuration can be mapped to one RadioLinkMonitoringConfig configuration, one RadioLinkMonitoringRS configuration, one RadioLinkMonitoringRS-Id, or one RLM RS. Accordingly, depending on which sub-configuration is used/applied/activated for CSI-RS reporting of the UE, the UE can apply the RadioLinkMonitoringConfig configuration, the RadioLinkMonitoringRS configuration, the RadioLinkMonitoringRS-Id, or the RLM RS mapped to the corresponding sub-configuration and perform RLM based on this. If N (N is an integer greater than 0) sub-configuration(s) are determined to be used/applied/activated (N<=L) among a total of L sub-configurations, the UE can select one sub-configuration among the N sub-configurations according to one of the following rules. And, the UE can perform RLM based on the RadioLinkMonitoringConfig configuration or RadioLinkMonitoringRS configuration or RadioLinkMonitoringRS-Id or RLM RS mapped to the selected sub-configuration.
Opt 1: Among N sub-configurations, the sub-configuration corresponding to the lowest sub-configuration index may be selected.
Opt 2: Among N sub-configurations, the sub-configuration corresponding to the highest sub-configuration index may be selected.
Opt 3: Among N sub-configurations, the sub-configuration corresponding to the sub-configuration index indicated by the base station via MAC CE or DCI may be selected.
Opt 4: Among N sub-configurations, the sub-configuration designated by the base station via an RRC message, or the sub-configuration corresponding to the default or highest priority may be selected.

According to one embodiment of the present disclosure, RLM-related parameters may be configured as follows. The RLM-related parameters may include parameters applicable to in-sync (IS) determination, out-of-sync (OOS) determination, RLF detection, etc.

First, RLM-related parameters for existing RLM and RLF detection operations will be described. After an activated RLM-RS is determined according to the examples described in the preceding embodiment, the operation described in the aforementioned “radio link monitoring (RLM) procedure” may be performed based on this.

In addition, the UE may perform RLM and RLF detection operations as shown in Table 8. Table 8 describes requirements applicable to RLM for the following PCell/PSCell/deactivated PSCell.
PCell in SA (standalone), NR-DC (NR NR-dual connectivity), and NE-DC (NR E-UTRA-dual connectivity) operation modes.
PSCell in NR-DC and EN-DC (E-UTRA NR-dual connectivity) operation modes.
Deactivated PSCell in NR-DC and EN-DC operation modes (if configured).

```
TABLE 8
  The UE shall monitor the downlink radio link quality based on the reference signal
configured as RLM-RS resource(s) in order to detect the downlink radio link quality of the
PCell, PSCell and deactivated PSCell (if configured with bfd-and-RLM with value true). The
configured RLM-RS resources can be all SSBs, or all CSI-RSs, or a mix of SSBs and CSI-
RSs. UE is not required to perform RLM outside the active DL BWP.
  On each RLM-RS resource, the UE shall estimate the downlink radio link quality and
compare it to the thresholds Qout and Qin for the purpose of monitoring downlink radio link
quality of the cell.
  When a CORESET that the UE uses for monitoring PDCCH includes two TCI states
and the UE is provided sfnSchemePdcch set to ‘sfnSchemeA’ or ‘sfnSchemeB’, the UE shall
estimate a single downlink radio link quality to derive single SNR and compare it to the
single thresholds Qout and Qin for the purpose of monitoring downlink radio link quality of
the cell(s). How to compute the single SNR based on two active TCI states is up to UE
implementation.
  The threshold Qout is defined as the level at which the downlink radio link cannot be
reliably received and shall correspond to the out-of-sync block error rate (BLERout). For
SSB based radio link monitoring, Qout_SSB is derived based on the hypothetical PDCCH
transmission parameters. For CSI-RS based radio link monitoring, Qout_CSI-RS is derived
based on the hypothetical PDCCH transmission parameters.
  The threshold Qin is defined as the level at which the downlink radio link quality can
be received with significantly higher reliability than at Qout and shall correspond to the in-
sync block error rate (BLERin). For SSB based radio link monitoring, Qin_SSB is derived
based on the hypothetical PDCCH transmission parameters. For CSI-RS based radio link
monitoring, Qin_CSI-RS is derived based on the hypothetical PDCCH transmission
parameters.
  The out-of-sync block error rate (BLERout) and in-sync block error rate (BLERin)
are determined from the network configuration via parameter
rlmInSyncOutOfSyncThreshold signalled by higher layers. When UE is not configured with
rlmInSyncOutOfSyncThreshold from the network, the UE defaults to BLEout=10% and
BLERin=2%, corresponding to the given configuration (configuration #0). All requirements
apply to BLER configuration #0.
  UE shall be able to monitor up to N_RLM RLM-RS resources of the same or different
types in each corresponding carrier frequency range, depending on a maximum number
Lmax of SSBs per half frame, where N_RLM is specified, and meet the requirements. if
RLM-RS is not configured and no TCI state for PDCCH is activated.
  For SSB based RLM,
  - UE shall be able to evaluate whether the downlink radio link quality on the
configured RLM-RS resource estimated over the last TEvaluate_out_SSB [ms] period
becomes worse than the threshold Qout_SSB within TEvaluate_out_SSB [ms] evaluation
period.
  - UE shall be able to evaluate whether the downlink radio link quality on the
configured RLM-RS resource estimated over the last TEvaluate_in_SSB [ms] period
becomes better than the threshold Qin_SSB within TEvaluate_in_SSB [ms] evaluation
period.
  For CSI-RS based RLM,
  - UE shall be able to evaluate whether the downlink radio link quality on the
configured RLM-RS resource estimated over the last TEvaluate_out_CSI-RS ms period
becomes worse than the threshold Qout_CSI-RS within TEvaluate_out_CSI-RS ms
evaluation period.
  - UE shall be able to evaluate whether the downlink radio link quality on the
configured RLM-RS resource estimated over the last TEvaluate_in_CSI-RS ms period
becomes better than the threshold Qin_CSI-RS within TEvaluate in CSI-RS ms evaluation
period.
```

If there is an RS used for RLM or an RS provided (hereinafter, “RS for RLM”), the UE measures the RS for RLM and determines that an RLF has been detected. Ifan RLF is detected, the UE reports the RLF to the base station or triggers an RRC connection re-establishment procedure. Once RRC connection re-establishment is triggered, a cell selection procedure is performed and a random access procedure is performed in the selected cell.

Table 9 describes the detection of a physical layer problem in the RRC_CONNECTED state and the related operation of the UE MAC layer.

```
TABLE 9
  The UE shall:
  1> if any DAPS (dual active protocol stack) bearer is configured, upon receiving
N310 consecutive “out-of-sync” indications for the source SpCell from lower layers and
T304 is running:
  2> start timer T310 for the source SpCell.
  1> upon receiving N310 consecutive “out-of-sync” indications for the SpCell from
lower layers while neither T300, T301, T304, T311, T316 nor T319 are running:
  2> start timer T310 for the corresponding SpCell.
  Recovery from physical layer problems is performed as follows:
  Upon receiving N311 consecutive “in-sync” indications for the SpCell from lower
layers while T310 is running, the UE shall:
  1> stop timer T310 for the corresponding SpCell.
  1> stop timer T312 for the corresponding SpCell, if running.
  Here, the UE may maintain the RRC connection without explicit signaling. That is,
the UE may maintain the entire radio resource configuration.
  In addition, periods in time where neither “in-sync” nor “out-of-sync” is reported by
L1 may not affect the evaluation of the number of consecutive “in-sync” or “out-of-sync”
indications.
  RLF detection is performed as follows.
  1> if any DAPS bearer is configured and T304 is running:
  2> upon T310 expiry in source SpCell; or
  2> upon random access problem indication from source MCG MAC; or
  2> upon indication from source MCG RLC that the maximum number of
retransmissions has been reached; or
  2> upon consistent uplink LBT (listen before talk) failure indication from source
MCG MAC:
  3> consider radio link failure to be detected for the source MCG i.e. source RLF;
  3> suspend the transmission and reception of all DRBs and multicast MRBs in the
source MCG;
  3> reset MAC for the source MCG;
  3> release the source connection.
  1> else:
  2> during a DAPS handover: the following only applies for the target PCell;
  2> upon T310 expiry in PCell; or
  2> upon T312 expiry in PCell; or
  2> upon random access problem indication from MCG MAC while neither T300,
T301, T304, T311 nor T319 are running; or
  2> upon indication from MCG RLC that the maximum number of retransmissions
has been reached; or
  2> if connected as an IAB-node, upon BH RLF indication received on BAP entity
from the MCG; or
  2> upon consistent uplink LBT failure indication from MCG MAC while T304 is
not running:
  3> if the indication is from MCG RLC and CA duplication is configured and
activated for MCG, and for the corresponding logical channel allowedServingCells only
includes SCell(s):
  4> initiate the failure information procedure to report RLC failure.
  3> else:
  4> consider radio link failure to be detected for the MCG, i.e. MCG RLF;
  4> discard any segments of segmented RRC messages stored
  4> if AS security has not been activated:
  5> perform the actions upon going to RRC_IDLE, with release cause ‘other’;
  4> else if AS security has been activated but SRB2 and at least one DRB or
multicast MRB or, for IAB, SRB2, have not been setup:
  5> store the radio link failure information in the VarRLF-Report;
  5> perform the actions upon going to RRC_IDLE, with release cause ‘RRC
connection failure’;
  4> else:
  5> store the radio link failure information in the VarRLF-Report;
  5> if T316 is configured; and
  5> if SCG transmission is not suspended; and
  5> if the SCG is not deactivated; and
  5> if neither PSCell change nor PSCell addition is ongoing (i.e. timer T304 for the
NR PSCell is not running in case of NR-DC or timer T307 of the E-UTRA PSCell is not
running, in NE-DC):
  6> initiate the MCG failure information procedure to report MCG radio link failure.
  5> else:
  6> initiate the connection re-establishment procedure.
```

Examples of RLM-related parameters used in the aforementioned operations are as follows: —TEvaluate_out_SSB: The length of the time interval associated with OOS evaluation for SSB-based RLMs;
TEvaluate_in_SSB: The length of the time interval associated with IS evaluation for SSB-based RLMs;
TEvaluate_out_CSI-RS: The length of the time interval associated with OOS evaluation for CSI-RS-based RLMs;
TEvaluate_in_CSI-RS: The length of the time interval associated with IS evaluation for CSI-RS-based RLMs;
rlmInSyncOutOfSyncThreshold: Setting the thresholds Qout and Qin;
Qout: The threshold associated with OOS evaluation;
Qin: Threshold associated with IS evaluation; powerControlOffsetSS: Power offset (in dB) between NZP CSI-RS REs and SSS REs;
nrofPorts: Number of antenna ports;
rsrp-ThresholdSSB: Threshold for SSB RSRP
rsrp-ThresholdBFR: Threshold for BFR RSRP;
BLERout: Block error rate associated with Qout;
BLERin: Block error rate associated with Qin;
Hypothetical PDCCH transmission parameters: number of control OFDM symbols, aggregation level (CCE), ratio of hypothetical PDCCH RE energy to average SSS RE energy, ratio of hypothetical PDCCH DMRS energy to average SSS DMRS energy, bandwidth, subcarrier spacing, DMRS precoder granularity, REG bundle size, CP length, REG to CCE mapping, etc.;
N_LR-RLM: maximum number of CSI-RS resources or SSB resources related to link recovery (LR) and RLM;
N_RLM: The maximum number of CSI-RS resources or SSB resources associated with RLM;
Lmax: The maximum number of SS/PBCH blocks per half-frame;
rlf-TimersAndConstants: Settings for timers (e.g., T310, T311) and counter values (e.g., N310, N311) associated with RLF;
T310: A timer started to detect a physical layer problem.
N310: A counter that increments by 1 when an out-of-sync indication is received from a lower layer while Timer T310 is stopped.
N311: A counter that increments by 1 when an in-sync indication is received from a lower layer while Timer T310 is running.

For some or all of the RLM-related parameters described above, the base station can configure different RLM-related parameter values for each sub-configuration or RLM-RS. In this case, the UE can apply the corresponding values to the RLM-related parameters to detect out-of-sync (OOS), in-sync (IS), or RLF, depending on which RLM-RS is valid and activated.

Alternatively, for some or all of the RLM-related parameters described above, the base station may configure different RLM-related parameter values depending on whether the mode is NES or non-NES, or whether the time period is the first or second period. In this case, the UE may apply the corresponding values to the RLM-related parameters to detect out-of-sync, in-sync, or RLF, depending on whether the currently indicated or configured mode is NES or non-NES, or whether the time period is the first or second time period.

Alternatively, different parameter values may be configured depending on which sub-configuration is being applied/used/activated. Accordingly, the UE may apply the parameters corresponding to the currently indicated, configured, or activated sub-configuration to detect out-of-sync, in-sync, or RLF.

Alternatively, for some or all of the RLM-related parameters as described above, the base station may configure different RLM-related parameter values depending on whether specific or some antenna ports (APs) are off (or disabled). In this case, the UE may detect out-of-sync or in-sync or RLF by applying the corresponding values to the RLM-related parameters depending on whether specific or some APs are off. Alternatively, the UE may detect out-of-sync or in-sync or RLF by applying the corresponding values to the parameters depending on which sub-configuration is applied/used/activated.

Alternatively, for some or all of the RLM-related parameters described above, the base station may configure different RLM-related parameter values depending on whether the transmit power of a specific or partial AP is reduced. In this case, the UE may apply the corresponding values to the RLM-related parameters, depending on whether the transmit power of a specific or partial AP is reduced, to detect out-of-sync, in-sync, or RLF.

In this regard, the base station may notify the UE of which AP is switched off and/or which AP's transmit power is reduced and/or which AP's transmit power is switched on and/or which AP's transmit power is increased or returned to normal power. This notification may be transmitted to the UE via DCI, MAC CE, or RRC messages.

In this case, the UE may be configured to detect IS/OOS/RLF by measuring L1-RSRP while excluding the specific or partial AP when the specific or partial AP is off. The UE may be configured to detect IS/OOS/RLF by measuring L1-RSRP without excluding (i.e., including) specific or some APs when they are not turned off. Similarly, the UE may be configured to detect IS/OOS/RLF by measuring L1-RSRP while excluding specific or some APs when their transmit power is reduced. The UE may be configured to detect IS/OOS/RLF by measuring L1-RSRP without excluding (i.e., including) specific or some APs when their transmit power is not reduced.

Additionally or alternatively, the UE may detect IS/OOS/RLF by applying an offset value to a value configured by the base station when a specific RS resource set or a specific sub-configuration is valid and activated for one or more of the aforementioned RLM-related parameters, and may detect IS/OOS/RLF by applying a value configured by the base station when another RS resource set or another sub-configuration is valid and activated (i.e., without applying an offset). Here, the offset may have a positive value or a negative value.

Additionally or alternatively, the UE may detect IS/OOS/RLF by applying a positive or negative offset value to a value configured by the base station when configured/indicated to NES mode or in the first period for one or more of the aforementioned RLM-related parameters, and may detect IS/OOS/RLF by applying a value configured by the base station (i.e., without applying an offset) when configured/indicated to non-NES mode or in the second period.

Additionally or alternatively, when configured or indicated to NES mode (i.e., when cell DTX and/or cell DRX are applied/configured) or in the first period, the UE may declare IS (in-sync) but may not declare OOS (out-of-sync). For example, in the first period, the counting of the consecutive OOS count for N310 (i.e., the counter count of out-of-sync associated with the start of a specific timer (T310 timer)) may be temporarily stopped (i.e., the counting of the OOS count may be suspended/paused), resumed from a previous value (i.e., from the counter value immediately before the counting was suspended/paused) or restarted from an initial value in non-NES mode (i.e., when cell DTX and/or cell DRX are not applied/configured) or immediately after switching to the second period. However, in the first period, the counting of the consecutive IS count for N311 (i.e., the counter count of in-sync associated with the stop of a specific timer (T310 timer)) may be continued (i.e., without stopping).

In addition, when configured or indicated to NES mode (i.e., when cell DTX and/or cell DRX are applied/configured) or when it is the first period, the UE may not declare both IS and OSS. In this case, the UE may temporarily not count both consecutive OOS counts and consecutive IS counts (i.e., suspend/pause counting of OOS/IS counts), resume counting from the previous value (i.e., from the counter value immediately before counting is suspended/paused) or restart counting from the initial value immediately after switching to non-NES mode (i.e., when cell DTX and/or cell DRX are not applied/configured) or the second period.

In addition, if the T310 timer (i.e., the timer used to determine whether to consider a radio link failure) is running when the mode is configured or indicated to be NES mode (i.e., when cell DTX and/or cell DRX are applied/configured) or when it is the first period, the timer may be temporarily stopped (i.e., the timer operation may be suspended/paused) and immediately after switching to non-NES mode (i.e., when cell DTX and/or cell DRX are not applied/configured) or the second period, the timer may be resumed from its previous value (i.e., from the timer value immediately before the timer operation was suspended/paused) or restarted from its initial value. However, if the T311 timer (i.e., the timer used to determine whether to perform an operation of transitioning the terminal to RRC_IDLE) is running even in the first period, the UE may continuously run the timer.

In addition, if the T310 timer and/or the T311 timer are running when the UE is configured to or indicated to be in NES mode (i.e., when cell DTX and/or cell DRX are applied/configured) or in the first period, the UE may temporarily suspend the timer(s) and immediately after switching to non-NES mode (i.e., when cell DTX and/or cell DRX are not applied/configured) or in the second period, resume the timer(s) from the previous value (i.e., from the timer value immediately before the timer operation was suspended/paused) or restart the timer(s) from the initial value.

Alternatively, if the UE is configured to or indicated to be in NES mode (i.e., when cell DTX and/or cell DRX are applied/configured) or in the first period, the UE may ignore the Radio Link Failure detected in the above-described manner and may not declare an RLF. Alternatively, the UE may declare an RLF but not report the RLF to the base station or trigger an RRC re-establishment procedure. On the other hand, in non-NES mode (i.e., when cell DTX and/or cell DRX are not applied/configured) or within the second period, the UE may not ignore an RLF detected in the above-described manner and may declare an RLF. Accordingly, the UE may report the RLF to the base station or trigger a re-establishment procedure.

Additionally or alternatively, the UE may detect IS/OOS/RLF by applying a positive or negative offset value to a value configured by the base station when an AP is in an off state for one or more of the aforementioned RLM-related parameters. Alternatively, the UE may detect IS/OOS/RLF by applying a value configured by the base station (i.e., without applying an offset) when an AP is not in an off state.

Additionally or alternatively, the UE may detect IS/OOS/RLF by applying a positive or negative offset value to a value configured by the base station when the transmit power of an AP is in a reduced state for one or more of the aforementioned RLM-related parameters.

Alternatively, the UE may detect IS/OOS/RLF by applying a value configured by the base station when the transmit power of an AP is not in a reduced state for one or more of the aforementioned RLM-related parameters.

In the examples described above, the offset value may be configured by the base station. The offset value may be set for each specific unit. For example, a particular unit may be defined by a combination of one or more of a cell, a BWP, a frequency resource, an RS for RLF, an AP, an AP group, or an antenna element group.

In the embodiment of the present disclosure described above, in the method of applying parameters according to sub-configuration, if among the total L sub-configurations (L is an integer greater than 0), it can be determined that N sub-configuration(s) (N is an integer greater than 0) are used/applied/activated (N<=L). In this case, the UE may select one of the N sub-configuration(s) according to one of the following rules, and detect out-of-sync or in-sync or RLF by applying parameters according to the selected specific sub-configuration.
Opt 1: Among N sub-configurations, the sub-configuration corresponding to the lowest sub-configuration index may be selected.
Opt 2: Among N sub-configurations, the sub-configuration corresponding to the highest sub-configuration index may be selected.
Opt 3: Among N sub-configurations, the sub-configuration corresponding to the sub-configuration index indicated by the base station via MAC CE or DCI may be selected.
Opt 4: Among N sub-configurations, the sub-configuration designated by the base station via an RRC message or corresponding to the default or highest priority may be selected.

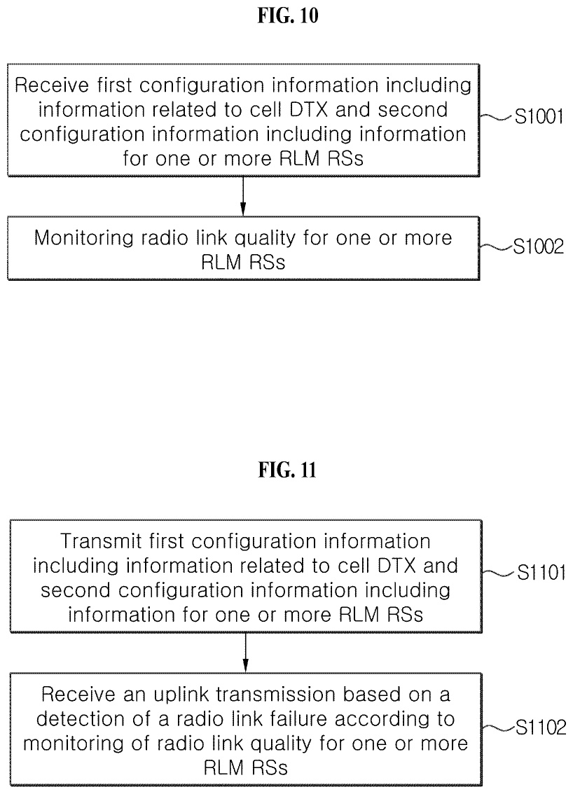

FIG. 10 is a diagram illustrating an operation of a UE for a radio link monitoring method according to an embodiment of the present disclosure.

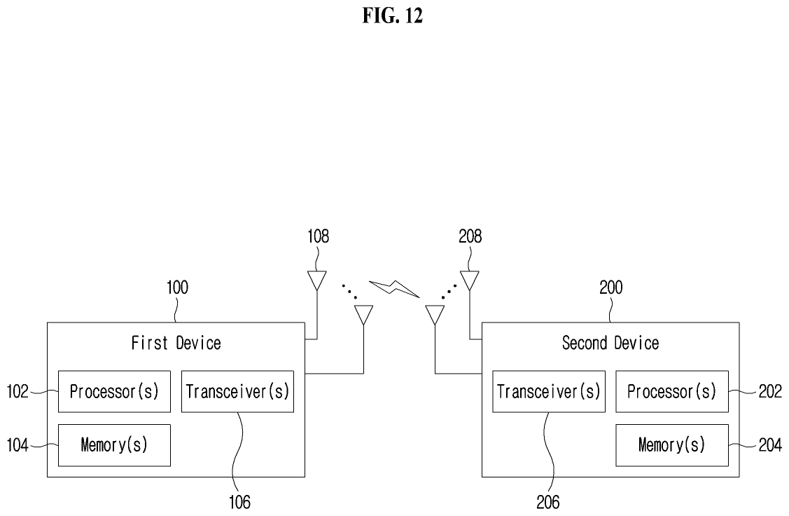

FIG. 10 illustrates the operation of a UE based on the previously proposed methods. The example in FIG. 10 is provided for convenience of explanation and does not limit the scope of the present disclosure. Some of the steps illustrated in FIG. 10 may be omitted depending on circumstances and/or settings. Furthermore, the UE in FIG. 10 is merely an example and may be implemented as the device illustrated in FIG. 12 below. For example, the processor (102/202) in FIG. 12 may control the transceiver (106/206) to transmit and receive channels/signals/data/information, etc., and may also control the memory (104/204) to store the transmitted or received channels/signals/data/information, etc.

In addition, the operation of FIG. 10 may be processed by one or more processors (102, 202) of FIG. 12, and the operation of FIG. 10 may be stored in a memory (e.g., one or more memories (104, 204) of FIG. 12) in the form of a command/program (e.g., an instruction, an executable code) for driving at least one processor (e.g., 102, 202) of FIG. 12.

A UE receives first configuration information including information related to cell DTX (i.e., information related to NES mode) and second configuration information including information for one or more RLM RSs from the base station (S1001).

Here, according to the present disclosure, the base station can activate or deactivate cell DTX and/or cell DRX (i.e., NES mode operation). Here, the base station can activate or deactivate cell DTX and/or cell DRX (i.e., NES mode operation) for each cell controlled by the base station, and can notify the UE of such cell DTX and/or cell DRX (i.e., NES mode operation) activation or deactivation information through the first configuration information.

That is, the first configuration information can include information related to cell DTX and/or cell DRX (i.e., NES mode operation) described in the proposed method described above. For example, the first configuration information may include information about a time period (or timer) during which cell DTX and/or cell DRX (i.e., NES mode operation) is activated (i.e., a time period during which the base station performs TX/RX for a specific cell) and/or information about a time period (or timer) during which cell DTX and/or cell DRX (i.e., NES mode operation) is deactivated (i.e., a time period during which the base station does not perform TX/RX for a specific cell).

Furthermore, according to the present disclosure, the second configuration information may include information about one or more RLM RSs (for a specific cell or group of cells). Furthermore, the second configuration information may include information about one or more parameters to be used for radio link monitoring for detecting beam radio link failure and/or cell radio link failure of the UE. Furthermore, the second configuration information may include information related to the radio link monitoring/failure operation described in the above-described embodiment, even if not specifically mentioned.

Here, one or more RLM RSs for the non-active period of the cell DTX and the active period of the cell DTX can be individually configured. For example, N (N is an integer greater than 0) sub-configurations related to a reference signal (or reference signal resource) can be configured. For example, N (N is an integer greater than 0) sub-configurations can be configured in the second configuration information. In this case, one or more sub-configurations among the N sub-configurations are mapped to the non-active period of the cell DTX, thereby configuring one or more RLM RSs for the non-active period of the cell DTX, and one or more sub-configurations among the N sub-configurations are mapped to the active period time interval of the cell DTX, thereby configuring one or more RLM RSs for the active period time interval of the cell DTX.

Additionally, although not illustrated in FIG. 10, the UE may receive configuration information for reporting channel state information from the base station. The configuration information for reporting channel state information may include information on a channel state information resource set, and N sub-configurations (N is an integer greater than 0) may be configured within the information on the channel state information resource set. In this case, based on the CSI-RS resources configured for CSI reporting, one or more RLM RSs may be individually configured for the non-active period of the cell DTX and/or the active period of the cell DTX.

A UE monitors radio link quality for one or more RLM RSs (S1002).

When the radio link quality is worse than a threshold, the lower layer of the UE may indicate an out-of-sync (OOS) to the higher layer. The higher layer of the UE may start a timer used to determine whether to consider an RLF based on a predetermined number of OOS indications from the lower layer (i.e., based on the OOS being counted continuously a predetermined number of times). The RLF may be considered based on the expiration of the timer used to determine whether to consider the RLF. Based on the RLF being considered, the UE may initiate a procedure for transmitting information related to the RLF (i.e., uplink transmission for RLF information) or initiate a procedure for re-establishing a connection (i.e., transmitting an RRC re-establishment request).

In addition, the lower layer of the UE may indicate to the higher layer that the radio link quality is better than the threshold. In addition, the timer used to determine whether to consider the RLF may be stopped based on the IS being continuously counted a predetermined number of times while the timer used to determine whether to consider the RLF may be running.

According to an embodiment of the present disclosure, the above-described operation may be performed in the active period of the cell DTX. However, in the non-active period of the cell DTX, the counting of the OOS and/or the operation of the timer used to determine whether to consider the RLF may be suspended. For example, based on entering the active period of the cell DTX from the non-active period of the cell DTX, the counting of the OOS and/or the operation of the timer may be restarted from an initial value. As another example, based on entering the active period of the cell DTX from the non-active period of the cell DTX, the counting of the OOS and/or the operation of the timer may be resumed from a value prior to entering the non-active period of the cell DTX. This means that the counting of the OOS and/or the operation of the timer are suspended in the non-active period of the cell DTX.

Furthermore, according to an embodiment of the present disclosure, while the counting of the OOS and/or the operation of the timer is suspended during the non-active period of the cell DTX, the counting of the in-sync (IS) can be continuously performed. Accordingly, the timer can be stopped based on the IS being continuously counted a predetermined number of times while the timer is running. That is, this is to prevent unnecessary radio link failures when the channel quality improves again during the non-active period of the cell DTX.

Furthermore, according to an embodiment of the present disclosure, based on the individual configuration of one or more RLM RSs for the non-active period of the cell DTX and the active period of the cell DTX, the UE can perform RLM using the corresponding RLM RS in each time period.

FIG. 11 is a diagram illustrating an operation of a base station for a beam failure detection method according to an embodiment of the present disclosure.

FIG. 11 illustrates the operation of a base station based on the previously proposed methods. The example in FIG. 11 is provided for convenience of explanation and does not limit the scope of the present disclosure. Some of the steps illustrated in FIG. 11 may be omitted depending on circumstances and/or settings. Furthermore, the base station in FIG. 11 is merely an example and may be implemented as the device illustrated in FIG. 12 below. For example, the processor (102/202) in FIG. 12 may control the transceiver (106/206) to transmit and receive channels/signals/data/information, etc., and may also control the memory (104/204) to store the transmitted or received channels/signals/data/information, etc.

In addition, the operation of FIG. 11 may be processed by one or more processors (102, 202) of FIG. 12, and the operation of FIG. 11 may be stored in a memory (e.g., one or more memories (104, 204) of FIG. 12) in the form of a command/program (e.g., an instruction, an executable code) for driving at least one processor (e.g., 102, 202) of FIG. 12.

Abase station transmits to a UE first configuration information including information related to cell DTX (i.e., information related to NES mode) and second configuration information including information for one or more RLM RSs (S1101).

Here, according to the present disclosure, the base station can activate or deactivate cell DTX and/or cell DRX (i.e., NES mode operation). Here, the base station can activate or deactivate cell DTX and/or cell DRX (i.e., NES mode operation) for each cell controlled by the base station, and can notify the UE of such cell DTX and/or cell DRX (i.e., NES mode operation) activation or deactivation information through the first configuration information. That is, the first configuration information can include information related to cell DTX and/or cell DRX (i.e., NES mode operation) described in the proposed method described above. For example, the first configuration information may include information about a time period (or timer) during which cell DTX and/or cell DRX (i.e., NES mode operation) is activated (i.e., a time period during which the base station performs TX/RX for a specific cell) and/or information about a time period (or timer) during which cell DTX and/or cell DRX (i.e., NES mode operation) is deactivated (i.e., a time period during which the base station does not perform TX/RX for a specific cell).

Furthermore, according to the present disclosure, the second configuration information may include information about one or more RLM RSs (for a specific cell or group of cells). Furthermore, the second configuration information may include information about one or more parameters to be used for radio link monitoring for detecting beam radio link failure and/or cell radio link failure of the UE. Furthermore, the second configuration information may include information related to the radio link monitoring/failure operation described in the above-described embodiment, even if not specifically mentioned.

Here, one or more RLM RSs for the non-active period of the cell DTX and the active period of the cell DTX can be individually configured. For example, N (N is an integer greater than 0) sub-configurations related to a reference signal (or reference signal resource) can be configured. For example, N (N is an integer greater than 0) sub-configurations can be configured in the second configuration information. In this case, one or more sub-configurations among the N sub-configurations are mapped to the non-active period of the cell DTX, thereby configuring one or more RLM RSs for the non-active period of the cell DTX, and one or more sub-configurations among the N sub-configurations are mapped to the active period time interval of the cell DTX, thereby configuring one or more RLM RSs for the active period time interval of the cell DTX.

Additionally, although not illustrated in FIG. 11, the base station may transmit configuration information for reporting channel state information to the UE. The configuration information for reporting channel state information may include information on a channel state information resource set, and N sub-configurations (N is an integer greater than 0) may be configured within the information on the channel state information resource set. In this case, based on the CSI-RS resources configured for CSI reporting, one or more RLM RSs may be individually configured for the non-active period of the cell DTX and/or the active period of the cell DTX.

Based on radio link quality monitoring for one or more RLM RSs by a UE, and the radio link failure is detected, a base station receives an uplink transmission from the UE (S1102).

Here, based on the RLF being considered by the UE, the base station may receive an uplink transmission for RLF information from the UE or receive an RRC re-establishment request.

When the radio link quality is worse than a threshold, the lower layer of the UE may indicate an out-of-sync (OOS) to the higher layer. The higher layer of the UE may start a timer used to determine whether to consider an RLF based on a predetermined number of OOS indications from the lower layer (i.e., based on the OOS being counted continuously a predetermined number of times). The RLF may be considered based on the expiration of the timer used to determine whether to consider the RLF. Based on the RLF being considered, the UE may initiate a procedure for transmitting information related to the RLF (i.e., uplink transmission for RLF information) or initiate a procedure for re-establishing a connection (i.e., transmitting an RRC re-establishment request).

In addition, the lower layer of the UE may indicate to the higher layer that the radio link quality is better than the threshold. In addition, the timer used to determine whether to consider the RLF may be stopped based on the IS being continuously counted a predetermined number of times while the timer used to determine whether to consider the RLF may be running.

According to an embodiment of the present disclosure, the above-described operation may be performed in the active period of the cell DTX. However, in the non-active period of the cell DTX, the counting of the OOS and/or the operation of the timer used to determine whether to consider the RLF may be suspended. For example, based on entering the active period of the cell DTX from the non-active period of the cell DTX, the counting of the OOS and/or the operation of the timer may be restarted from an initial value. As another example, based on entering the active period of the cell DTX from the non-active period of the cell DTX, the counting of the OOS and/or the operation of the timer may be resumed from a value prior to entering the non-active period of the cell DTX. This means that the counting of the OOS and/or the operation of the timer are suspended in the non-active period of the cell DTX.

Furthermore, according to an embodiment of the present disclosure, while the counting of the OOS and/or the operation of the timer is suspended during the non-active period of the cell DTX, the counting of the in-sync (IS) can be continuously performed. Accordingly, the timer can be stopped based on the IS being continuously counted a predetermined number of times while the timer is running. That is, this is to prevent unnecessary radio link failures when the channel quality improves again during the non-active period of the cell DTX.

Furthermore, according to an embodiment of the present disclosure, based on the individual configuration of one or more RLM RSs for the non-active period of the cell DTX and the active period of the cell DTX, the UE can perform RLM using the corresponding RLM RS in each time period.

General Device to which the Present Disclosure May be Applied

FIG. 12 is a diagram which illustrates a block diagram of a wireless communication device according to an embodiment of the present disclosure.

In reference to FIG. 12, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal.

For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

### INDUSTRIAL AVAILABILITY

A method proposed by the present disclosure is mainly described based on an example applied to 3GPP LTE/LTE-A, 5G system, but may be applied to various wireless communication systems other than the 3GPP LTE/LTE-A, 5G system.

1. A method performed a user equipment (UE) in a wireless communication system, the method comprising:
receiving first configuration information and second configuration information from a base station, wherein the first configuration information includes information related to cell discontinuous transmission (DTX), and the second configuration information includes information for one or more radio link monitoring (RLM) reference signals (RS); and
monitoring radio link quality for the one or more RLM RSs,
wherein, based on out-of-sync (OOS), indicated by the radio link quality being lower than a threshold, being continuously counted a predetermined number of times, a timer used to determine whether a radio link failure (RLF) is considered is started, and
wherein an counting of the OOS and/or an operation of the timer is suspended during a non-active period of the cell DTX.

2. The method of claim 1, wherein based on a transition from the non-active period of the cell DTX to an active period of the cell DTX, the counting of the OOS and/or the operation of the timer are restarted from an initial value.

3. The method of claim 1, wherein based on a transition from the non-active period of the cell DTX to an active period of the cell DTX, the counting of the OOS and/or the operation of the timer are resumed from a value prior to a transition to the non-active period of the cell DTX.

4. The method of claim 1, wherein in-sync (IS), indicated by the radio link quality being higher than a threshold, is counted during the non-active period of the cell DTX.

5. The method of claim 4, wherein the timer is stopped based on the IS being continuously counted a predetermined number of times while the timer is running.

6. The method of claim 1, wherein one or more RLM RSs for the non-active period of the cell DTX and the active period of the cell DTX are individually configured.

7. The method of claim 6, wherein N sub-configurations (N is an integer greater than 0) related to RSs are configured,
wherein by one or more sub-configurations among the N sub-configurations being mapped to the non-active period of the cell DTX, the one or more RLM RSs are configured for the non-active period of the cell DTX, and
wherein by one or more sub-configurations among the N sub-configurations being mapped to the active period of the cell DTX, one or more RLM RSs are configured for the active period of the cell DTX.

8. The method of claim 7, wherein the N sub-configurations (N is an integer greater than 0) are configured within a channel state information (CSI) resource set.

9. The method of claim 1, wherein the RLF is determined based on an expiration of the timer.

10. The method of claim 1, wherein, based on the RLF being determined, a procedure for transmitting information related to the RLF or a connection re-establishment procedure is initiated.

11. A user equipment (UE) operating in a wireless communication system, the UE comprising:
at least one transceiver for transmitting and receiving a wireless signal; and
at least one processor for controlling the at least one transceiver,
wherein the at least one processor configured to:
receive first configuration information and second configuration information from a base station, wherein the first configuration information includes information related to cell discontinuous transmission (DTX), and the second configuration information includes information for one or more radio link monitoring (RLM) reference signals (RS); and
monitor radio link quality for the one or more RLM RSs,
wherein, based on out-of-sync (OOS), indicated by the radio link quality being lower than a threshold, being continuously counted a predetermined number of times, a timer used to determine whether a radio link failure (RLF) is considered is started, and
wherein an counting of the OOS and/or an operation of the timer is suspended during a non-active period of the cell DTX.

12-14. (canceled)

15. A base station operating in a wireless communication system, the base station comprising:
at least one transceiver for transmitting and receiving a wireless signal; and
at least one processor for controlling the at least one transceiver,
wherein the at least one processor configured to:
transmit first configuration information and second configuration information from a base station, wherein the first configuration information includes information related to cell discontinuous transmission (DTX), and the second configuration information includes information for one or more radio link monitoring (RLM) reference signals (RS); and
receive an uplink transmission from the UE based on a detection of a radio link failure (RLF) based on monitoring of radio link quality for the one or more RLM RSs by the UE,
wherein, based on out-of-sync (OOS), indicated by the radio link quality being lower than a threshold, being continuously counted a predetermined number of times, a timer used to determine whether a radio link failure (RLF) is considered is started, and
wherein an counting of the OOS and/or an operation of the timer is suspended during a non-active period of the cell DTX.
